(19) United States
(12) Patent Application Publication
(10) Pub. No.: US 2018/0007614 A1
(43) Pub. Date: Jan. 4, 2018

(54) MITIGATION OF SIGNALLING CONGESTION IN CELLULAR NETWORKS

(71) Applicant: NEC Europe Ltd., Heidelberg (DE)

(72) Inventors: Genadi Velev, Darmstadt (DE); Andreas Kunz, Ladenburg (DE); Iskren Ianev, Berkshire (GB)

(21) Appl. No.: 15/544,892

(22) PCT Filed: Jul. 16, 2015
(86) PCT No.: PCT/EP2015/066267

§ 371 Date: Jul. 20, 2017

(30) Foreign Application Priority Data
Jan. 21, 2015 (EP) 15151953.5

(51) Int. Cl. H04W 48/06; H04W 28/02; H04W 8/18; H04W 88/02

(52) U.S. Cl. CPC H04W 48/06; H04W 28/0289; H04W 8/18; H04W 88/02

(57) ABSTRACT

A method for signalling congestion avoidance based on Non-Access Stratum (NAS) level congestion control in a mobile network includes activating or starting a group specific NAS level congestion control mechanism that applies to a group of terminals; receiving at a serving node of a terminal of the group of terminals an NAS Session Management (SM) request message from the terminal related to a particular access point name (APN); and transmitting from the serving node of the terminal to the terminal one or more NAS reject messages that indicate suppression or prevention of NAS SM signalling of the terminal that is related either to all APNs to which the terminal has established or activated IP bearers or to all APNs to which the terminal has a subscription.

### CROSS REFERENCE TO RELATED APPLICATIONS

This application is a U.S. National Stage Application under 35 U.S.C. §371 of International Application No. PCT/EP2015/066267 filed on Jul. 16, 2015, and claims benefit to European Patent Application No. EP 15151953.5 filed on Jan. 21, 2015. The International Application was published in English on Jul. 28, 2016 as WO 2016/116174 A1 under PCT Article 21(2).

### FIELD

The present invention relates to a method for signalling congestion avoidance based on NAS, Non-Access Stratum, level congestion control in a mobile network. Furthermore, the present invention relates to a terminal device for use in a mobile network and to a serving node for use in a mobile network.

### BACKGROUND

Due to the increased number of mobile users (subscribers, or end devices, or terminals, or user equipment, UE as used in 3GPP terminology) in the mobile networks, mobile operators are facing the problems of congestion/overload in both control plane and user/data plane. The signalling in the control plane is usually caused by the user mobility in IDLE and CONNECTED state, but also due to establishment, deactivation or modification procedures of IP bearers (in 3GPP called Evolved Packet System, EPS bearer).

The control plane signalling includes on one side the signalling between the UE and the serving network node, i.e. the Non-Access Stratum signalling between UE and MSC/SGSN/MME, and on the other side the signalling within the core network between the serving node and the user plane gateways for the establishment, modification or deactivation of IP bearers. Generally, the NAS signalling between UE and MSC/SGSN/MME can be categorized as Mobility Management (MM) signalling, Session Management (SM) signalling, and Call Control signalling (e.g. in circuit-switched domains).

3^{rd} Generation partnership project (3GPP) developed in Release 10 mechanisms to prevent signalling increase from the users in case of control plane congestion, which is described in 3GPP TS23.401 V13.1.0 (this version is used as reference throughout the present specification) section 4.3.7.4. As described, the NAS level congestion control can be activated for NAS Mobility Management (MM) signalling or NAS Session Management (SM) signalling. The present invention focuses on the NAS Session Management congestion control (for shorter the abbreviation NAS SM CC is used).

The NAS SM CC can be activated by the network, mainly by the serving network node (in 3GPP the serving network node is MSC, MME or SGSN), due to increased SM signalling from the UEs on one of the following criteria as per 3GPP TS23.401:
Maximum number of active EPS bearers per APN;
Maximum rate of EPS Bearer activations per APN;
One or multiple PDN GWs of an APN are not reachable or indicated congestion to the MME;
Maximum rate of MM signalling requests associated with the devices with a particular subscribed APN; and/or
Setting in network management.

The serving network node can activate the congestion control when one or several of the above listed criteria take place. Then the serving network node rejects NAS SM requests from the UEs using a congestion cause and optionally including a Session Management Back-Off timer (SM BOT). Until the SM BOT expires in the UE, the UE is not allowed to send any MM or SM signalling. According to 3GPP TS24.301 v12.6.0 (this TS version is used as reference throughout the present specification) and TS24.008 v12.7.0 (this TS version is used as reference throughout the present specification) the SM BOT is called T3396.

If a NAS signalling message containing the low priority indicator set to “UE/MS is configured for NAS signalling low priority” is rejected with timer T3396 and SM cause value #26 “insufficient resources”, the UE is not allowed to send any further NAS SM signalling for the specific APN as long as the timer T3396 is running. The detailed behaviour of the MME and UE is described in 3GPP TS23.401 section 4.3.7.4.2.2 “APN based Session Management congestion control”.

In 3GPP Release 13 a new study on “Group based Enhancements” is carried out. This study includes evaluation of architectural enhancements required for Group based feature, e.g. Message delivery to a group of devices, Group based Policy Control, Group-specific NAS Level Congestion Control, Group based addressing and identifiers, etc. Operators cannot control individual groups of UEs efficiently. Misbehavior of UEs (e.g. due to unavailable services) may disturb network performance. The Group-based NAS level CC allows operators to control the UE-initiated signalling on a finer granularity, not only based on APN or LAPI granularity as possible with pre Rel-13 mechanisms. The network operator can group the UEs based on subscription characteristics. The current version of the document describing the study is 3GPP TR23.769 v1.0.0 (this TR version is used as reference throughout the present specification).

### SUMMARY

In an embodiment, the present invention provides a method for signalling congestion avoidance based on Non-Access Stratum (NAS) level congestion control in a mobile network. The method includes activating or starting a group specific NAS level congestion control mechanism that applies to a group of terminals; receiving at a serving node of a terminal of the group of terminals an NAS Session Management (SM) request message from the terminal related to a particular access point name (APN); and transmitting from the serving node of the terminal to the terminal one or more NAS reject messages that indicate suppression or prevention of NAS SM signalling of the terminal that is related either to all APNs to which the terminal has established or activated IP bearers or to all APNs to which the terminal has a subscription.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a flow diagram illustrating a possible solution for congestion mitigation without terminal/UE impact;

FIG. 2 is a flow diagram illustrating a solution for congestion mitigation without terminal/UE impact in accordance with an embodiment of the present invention;

FIG. 3 is a flow diagram illustrating a solution for congestion mitigation with terminal/UE impact in accordance with an embodiment of the present invention; and

FIG. 4 is a flow diagram illustrating an alternative solution for congestion mitigation with terminal/UE impact in accordance with an embodiment of the present invention.

### DETAILED DESCRIPTION

Embodiments of the present invention address the problem and solution described in section 5.4 “Key issue—Group-specific NAS Level Congestion Control”, which is incorporated herein by way of reference. The idea is that the serving network node (MSC/SGSN/MME) can activate NAS congestion control mechanism based on increased NAS signalling generated from members of a group. The group of UE is configured internally in the network. It is assumed that a UE's subscription contains a Group ID, which is transferred to the serving node during the context transfer procedure from HSS to the serving node. With other words, the Group-specific NAS Level Congestion Control includes both NAS SM and NAS MM congestion control based on internal Group ID contained in the subscription.

The grouping in the network can be performed based on different conditions, for example independent of a specific set of group features. As described in 3GPP TR23.769 v1.0.0, group identifiers used for identifying users belonging to a group for delivery of message(s) to the group can be different from group identifiers used for policing and can be different to group identifiers for NAS level congestion control. With other words, groups can be based on UE subscription characteristics (e.g. pre-paid user from supermarket chain) and/or based on Application/service (e.g. UEs communicating to utility company “ABC”).

The Group based NAS level signalling congestion can be associated with a Group of UEs belonging to the same 3GPP internal group ID. The 3GPP internal group ID is configured in the UE's context in the HSS and transfered to the MME during the Attach procedure. The (E)SM congestion control is applied for all APNs of the UE that belong to the said particular group, but not for a specific APN of the UE.

For the sake of completeness it should be noted that, generally, there is another possibily to apply the Group based NAS level signalling congestion in connection with the APN based congestion control. In such a case the MSC/SGSN/MME detects NAS signalling congestion associated with the Group of UEs belonging to the same 3GPP internal group ID and targeting for a particular APN. However, this possibility does not impact the procedure(s) how NAS level congestion control is activated in the UE, but merely extends the criteria for detecting the NAS level signalling congestion in the MME.

The solution in 3GPP TR23.769 v1.0.0 section 5.4 does not describe the details how exactly the UE is prevented from sending NAS SM signalling for any APN. Currently the serving node can only prevent the NAS SM signalling from the UE per APN. Usually, the NAS SM reject message from the serving node (NAS ESM Reject message or Deactivate EPS Bearer Context Request message) contains the EPS bearer ID, so that the UE applies the SM BOT merely to the APN related to the EPS bearer ID. Further, it is not clear, how the Group-specific NAS level congestion control is activated if the UEs members of the same group are attached/registered with different serving nodes.

Embodiments of the present invention provide a method for signalling congestion avoidance in a mobile network of the initially mentioned type and a terminal device as well as a serving node for use in a mobile network in such a way that by means of minimal signalling from the serving network node to the UE the UE is reliably and effectively prevented from sending NAS (E)SM signalling to the network due to Group-specific NAS level congestion control.

According to an embodiment, a method is provided for signalling congestion avoidance based on NAS, Non-Access Stratum, level congestion control in a mobile network, wherein the method comprises: activating or starting a group specific NAS level congestion control mechanism that applies to a group of terminals, receiving at a serving node of a terminal of said group a NAS Session Management, SM, request message from said terminal related to a particular access point name, APN, and transmitting from said terminal's serving node to said terminal one or more NAS reject messages that indicate suppression or prevention of said terminal's NAS SM signalling that is related either to all APNs to which said terminal has established or activated IP bearers or to all APNs to which said terminal has a subscription.

According to an embodiment, a terminal device is provided for use in a mobile network, the terminal device comprising: a communications unit for communication with a serving node within said mobile network, and a control unit for controlling operation of said communications unit, wherein said control unit is configured to instruct said communications unit, upon receiving from said serving node one or more NAS reject messages that indicate suppression or prevention of said terminal's NAS SM signalling that is related either to all APNs to which said terminal has established or activated IP bearers or to all APNs to which said terminal has a subscription, to not initiate any NAS SM signalling related to the respective APNs.

According to an embodiment, a serving node is provided for use in a mobile network, the serving node comprising: a communications unit for transmitting and receiving messages, and a control unit for controlling operation of said communications unit, wherein said control unit is configured to detect when a group specific NAS level congestion control mechanism that applies to a group of terminals is activated within said mobile network, and wherein said control unit is further configured to instruct said communications unit, upon receiving from a terminal of said group a NAS SM request message related to a particular APN, to transmit to said terminal one or more NAS reject messages that indicate suppression or prevention of said terminal's NAS SM signalling that is related either to all APNs to which said terminal has established or activated IP bearers or to all APNs to which said terminal has a subscription.

According to the invention it has been recognized that with existing prior art solutions it is not possible to prevent the NAS SM signalling for all APNs and that even the prevention of NAS SM signalling for those APNs to which the terminal has subscribed requires extensive signaling. Therefore, embodiments of the present invention reduce signalling from the serving network node to the terminal in order to prevent the terminal from sending NAS (E)SM signalling to the network due to Group-specific NAS level congestion control. In particular, once the network activates the Group-specific NAS level congestion control, the present invention proposes that the serving node indicates to the UE—by means of specific NAS reject messages—that the (E)SM signalling to all APNs, to which the terminal has established or activated IP bearers, or to all APNs, to which the UE is subscribed (but has not activated an IP bearer yet), should be suppressed for a certain period of time. The suppression of signalling from the UE can be achieved through a back-off timer(s) indicated by the serving node.

Specifically, embodiments of the present invention therefore focus on a scenario where the (E)SM congestion control is applied for all (subscribed) APNs of a terminal that belongs to the particular group (e.g. having a common group identifier), and not for a specific APN of the terminal, and where the NAS (E)SM message from the serving network node to the terminal/UE has the scope for all activated and/or not activated (E)PS bearer contexts or DPD/PDN connections for all subscribed APNs.

The group of terminals/UEs can be an internal group, i.e. the group is defined and maintained by the mobile network operator and used mainly (but exclusively) for applying common policies and/or for NAS level congestion control. The group of terminals/UEs can be also an external group, i.e. the group is defined and maintained by a 3^{rd} party (external or internal) service provider and such groups can be e.g. used for delivery of message(s) to the group of terminals/UEs. For external groups the mapping of external identifiers and internal identifiers is needed. Such a mapping can be done e.g. at the SCEF or HSS. In the following description a simplified term of “group” and “group ID” will be used, which can include internal or external groups and correspondingly internal ID and external ID.

According to embodiments of the invention it may be provided that the terminal's serving node, upon receiving from the terminal a NAS SM request message related to a particular APN, transmits to the terminal a general NAS SM reject message related to all APNs to which the terminal has a subscription or a general NAS Mobility Management, MM, reject message related to all APNs to which the terminal has a subscription. Specifically, it may be provided that this reject message is a new NAS SM reject message or a new NAS MM reject message introduced for common/general SM (or MM) information exchange between the terminal and the serving network node. To indicate that the NAS SM (or MM) reject message is a common/general SM (or MM) reject message, new type(s) of message(s) could be specified in the (E)SM protocol.

According to embodiments of the invention it may be provided that the terminal's serving node, upon receiving from the terminal a NAS SM request message related to a particular APN, transmits to the terminal a NAS SM reject message or NAS MM reject message that is adapted to contain an information element, IE; that indicates to the terminal that the NAS SM reject message (or the NAS MM reject message, respectively), i.e. the information elements contained within this message, relate to all APNs to which the terminal has a subscription (i.e. to all existing (E)SM contexts or to all possible (E)SM procedures or (E)SM signalling). For instance, it may be provided that if this new “general” IE is included in the NAS SM (or MM) reject message and also a SM BOT IE is included, then the SM BOT is valid for the (E)SM signalling from the terminal for all (subscribed) APNs.

Correspondingly, according to embodiments of the terminal device of the present invention it may be provided that the terminal device's control unit is configured, upon receiving at the communications unit a NAS SM reject message or NAS MM reject message containing such IE (i.e. an information element that indicates that the NAS SM (or MM) reject message relates to all APNs to which the terminal has a subscription), to instruct the terminal device's communications unit to not initiate any NAS SM signalling related to the respective APNs.

According to embodiments of the invention it may be provided that the terminal's serving node, upon receiving from the terminal a NAS SM request message related to a particular APN, transmits to the terminal a NAS SM reject message (or NAS MM reject message) that is adapted to contain a back-off timer for the terminal's NAS SM signalling suppression or prevention configured to apply to all APNs to which the terminal has a subscription. For instance, an existing NAS SM (or MM) reject message can be used, but a new type of (E)SM back-off timer is introduced, whose scope is for (a) all activated (E)PS bearer/DPD/PDN contexts and/or for (b) all (subscribed) APNs. This new (E)SM BOT time(r) could be called “Group” (E)SM BOT, and a new timer type value could be assigned to this Group (E)SM timer.

Correspondingly, according to embodiments of the terminal device of the present invention it may be provided that the terminal device's control unit is configured, upon receiving at the communications unit a NAS SM (or MM) reject message containing such a back-off timer for the terminal's NAS SM signalling suppression or prevention (i.e. a back-off timer that is configured to apply to all APNs to which the terminal has a subscription), to instruct the terminal device's communications unit to not initiate any NAS SM signalling related to the respective APNs while the back-off timer is running.

According to embodiments of the invention it may be provided that the terminal's serving node, upon receiving from the terminal a NAS SM request message related to a particular APN, transmits to the terminal a NAS SM (or MM) reject message that is adapted to contain a list of APNs that indicates those APNs to which the NAS SM (or MM) reject message applies. Specifically, it may be provided that an existing NAS SM (or MM) reject message is used, wherein this message includes a list of APNs or EPS bearer IDs, to which the other parameters within this message apply. For example, the NAS SM (or MM) reject message can be sent as reply message to a particular NAS SM request (i.e. within a particular EPC bearer context), however, if the NAS SM (or MM) reject message contains a list of additional EPS bearer IDs, or APNs, or other indicators or (E)PS bearer contexts, the receiving terminal applies the parameters of this message to the indicated list of (E)PS bearer contexts or APNs.

Correspondingly, according to embodiments of the terminal device of the present invention it may be provided that the terminal device's control unit is configured, upon receiving at the communications unit such a NAS SM (or MM) reject message (i.e. a message containing a list of APNs that indicates those APNs to which this message and the (other) parameters contained therein apply), to instruct the terminal device's communications unit to not initiate any NAS SM signalling related to those APNs indicated in the list.

According to embodiments of the invention it may be provided that the terminal's serving node, upon receiving from the terminal a NAS SM request message related to a particular APN, transmits to the terminal individual NAS SM reject messages per each APN to which said terminal has established or activated IP bearers. Advantageously, these individual NAS SM reject messages are transmitted in parallel/concurrently, i.e. in particular without waiting for any NAS SM request messages from the terminal for other (E)PS bearers or APNs or DPD/PDN connections. Additionally or alternatively, it may be provided that a value of a back-off timer for the terminal's NAS SM signalling suppression or prevention that is contained in the individual NAS SM reject messages is the same for all of the individual NAS SM reject messages.

With respect to embodiments of the serving node according to the present invention it may be provided that the serving node's control unit is configured, upon receiving at the communications unit a NAS SM request message from a terminal, to determine whether the terminal belongs to a group for which an activated group specific NAS level congestion control mechanism applies. To this end it may be provided that the serving node analyzes the terminals subscription context as furnished at the HSS.

According to embodiments of the invention the mobile network may be a 3G UMTS network or a 4G LTE network and the serving node may be an SGSN or an MME. Alternatively, the mobile network may be a 2G GSM network and the serving node an MSC. As will be easily appreciated by those skilled in the art, the present invention may also be applied in any future mobile communication system that implements the concept of a mobile device and a serving network entity in the network controlling the requests and behaviour of the mobile device.

Embodiments of the present invention as described hereinafter generally apply to all mobile networks systems and/or access technologies, i.e. 2G GSM, 3G UTRAN/UMST and 4G LTE/EPS systems or any other mobile communication system with the concept of a mobile device and a serving network entity in the network controlling the requests and behaviour of the mobile device. Therefore, the terminology of all mobile network technologies/generations applies to embodiments of the present invention. In particular, the following terminology is used in the context of the subsequent embodiments:

NAS (E)SM signalling: Non-Access Stratum EPS Session Management as used in 3GPP TS24.301 and TS24.008. For simplicity, the present descriptions also uses NAS SM or (E)SM signalling or just SM signalling. Usually, in 4G LTE/EPS systems, the NAS ESM is used to denote the Session Management signalling between the UE and the MME. The ESM procedures may include PDN connectivity procedures, Default/Dedicated EPS bearer context activation, EPS bearer context modification procedure, EPS bearer context deactivation procedure, or the like.

In 3G UMTS/UTRAN systems, the NAS SM is used to denote the Session Management signalling between the UE and the SGSN. As embodiments of the invention apply to both LTE/EPS and UTRAN/UMTS systems, “E” in brackets is used in front of the SM, i.e. “(E)SM”. The main function of the 3G session management (SM) is to support PDP context handling of the user terminal. The SM comprises procedures for identified PDP context activation, deactivation and modification and identified MBMS context activation and deactivation. Thus, the term (E)SM signalling as used herein applies also to the PDP context SM procedures as listed above.

Accordingly embodiments of the invention also apply to 2G GSM systems, where the NAS SM signalling is between the UE and the MSC.

NAS (E)SM BOT: Non-Access Stratum EPS Session Management Back-Off Time(r). In some parts of the present description simply “NAS SM BOT” or “(E)SM BOT” can be used in exchangeable manner. The meaning of all abbreviations is the same, i.e. the time activated in the UE, for which the UE suppresses the NAS (E)SM signalling. As per the state-of-the-art, the NAS (E)SM BOT has the meaning per APN, but embodiments of the present invention extend the meaning for the NAS (E)SM to (1) all APNs to which the UE has currently activated EPS bearer contexts as per solution without UE impact; or to (2) all APNs subscribed by the UE as per solution with UE impact.

Serving network node: Usually this is the entity terminating the NAS signalling from the UE and responsible for the mobility management and session management of the UE or MS connections. The serving network node is called Mobile Switching Centre (MSC) in 2G, Serving GPRS Support Node (SGSN) in 3G and Mobility Management Entity (MME) in 4G.

UE: a User Equipment which denotes a terminal comprising all user equipment (hardware radio modem) and software needed for communication with a mobile network. In 2G systems the term “UE” corresponds more-or-less to Mobile Station (MS). Generally, the term “UE” is to be understood to also constitute terms like mobile terminal or mobile node or mobile equipment.

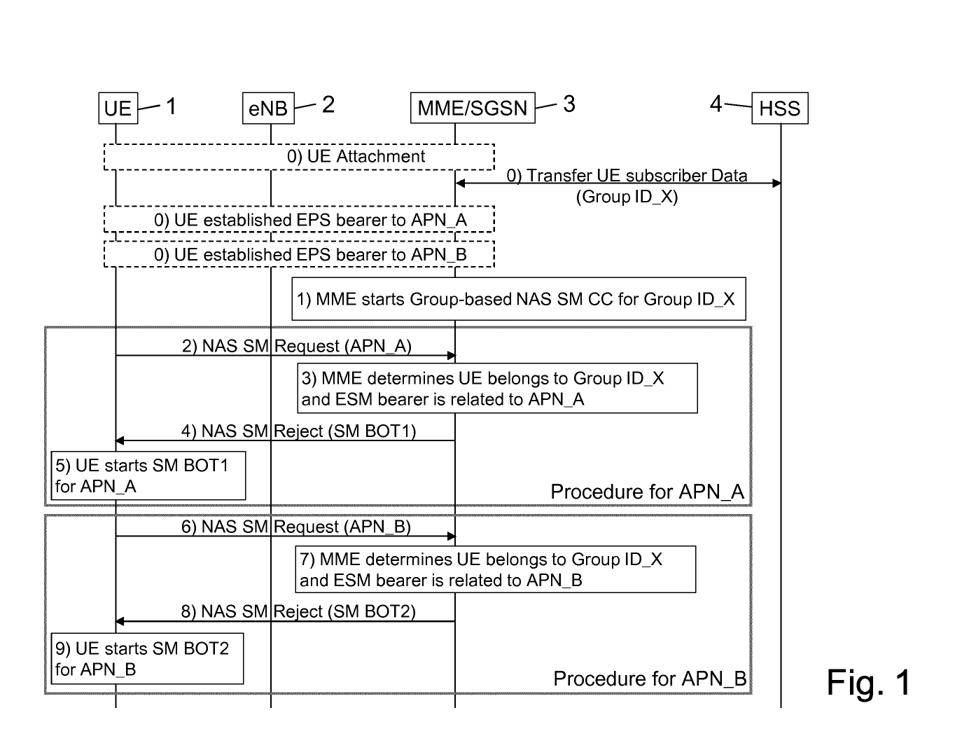

Generally, a possible approach to achieve the objective of preventing the NAS SM signalling from UE for all APNs is that the serving node matches all subscribed UE's APNs as congested and whenever a NAS SM request message arrives from the UE for a distinct APN, the serving node rejects the request with the corresponding APN and SM BOT. FIG. 1 shows an exemplary signalling flow diagram for this possible solution.

During step 0) the UE 1 attaches to the network via eNB 2. Further, after some time, the UE 1 activates separate EPS bearers to APN_A and APN_B. Step 1) shows that the serving node, MME 3, activates the Group-based NAS level SM congestion control for Group X (indicated by Group ID_X). During steps 2), 3) and 4) the UE 1 sends a NAS (E)SM request message to the MME 3 (e.g. to modify existing bearer resources), and the MME 3 detects that the UE 1 is member of the congested Group ID_X. The MME 3 rejects the UE's 1 request and includes a SM BOT in the (E)SM Reject message. The value of the SM BOT is indicated as “BOT1”. At step 5), the UE 1 activates the SM BOT timer for all (E)SM signalling related to the APN_A.

During steps 6), 7) and 8) the UE 1 sends a NAS (E)SM request to the MME 3 related to APN_B. The MME 3 detects again that the UE 1 is member of the congested Group ID_X. The MME 3 rejects the UE's 1 request and includes a SM BOT in the SM Reject message. The value of the SM BOT is indicated as “BOT2”. At step 9), the UE 1 activates the SM BOT timer for all (E)SM signalling related to the APN_B.

A disadvantage of the possible solution as shown in FIG. 1 is that after the first NAS (E)SM Reject procedure for one APN (e.g. APN_A), the UE 1 is still allowed to send NAS (E)SM signalling related to other subscribed APNs. Thus, the serving node rejects the UE's (E)SM signalling separately per each APN. This results in undesirable NAS ESM signalling from the UE 1, and this especially in case of NAS SM congestion situation. Further, in order to send the (E)SM request for APN_B, a NAS signalling connection between UE 1 and MME 3 is needed. In case NAS signalling connection does not exist, the UE 1 needs to perform Service Request procedure in advance, which results in even more RAN and NAS signalling initiated by the UE 1, which contributes to the signalling congestion situation.

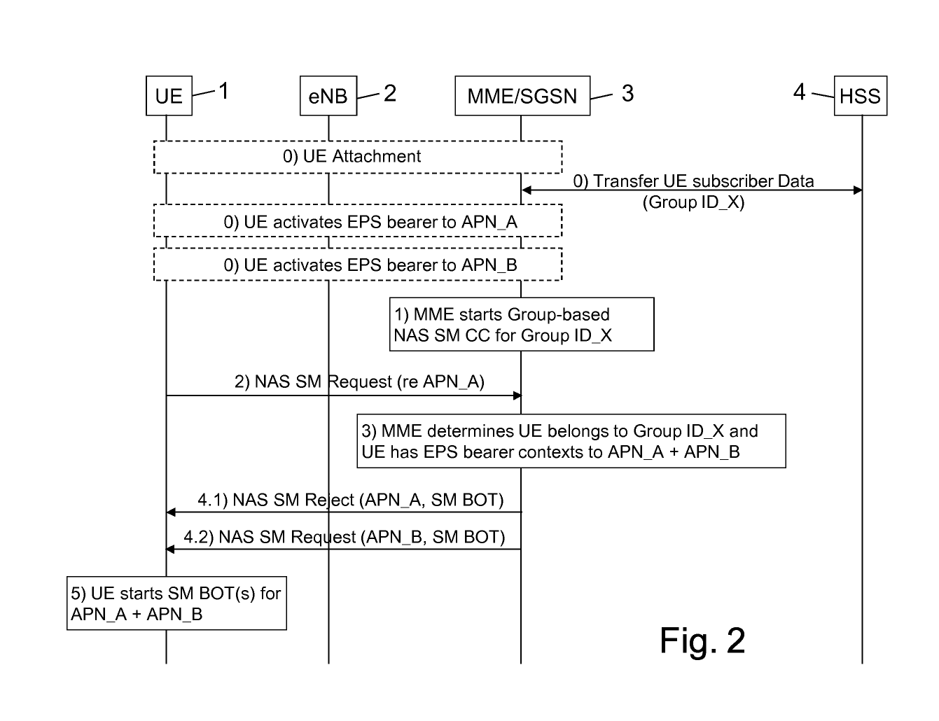

FIG. 2 illustrates an exemplary signalling flow based on a solution in accordance with an embodiment of the present invention without terminal/UE 1 impact that overcomes the above disadvantage coming along with the solution of FIG. 1. In FIG. 2, like reference numbers denote like components as in FIG. 1.

Generally, if Group-specific (or Group-based) NAS level (E)SM congestion control (CC) applies, after receiving NAS (E)SM signalling from the UE 1 which is a member of the Group causing the NAS (E)SM CC, the serving node (MSC/MME/SGSN) 3 sends a NAS (E)SM message including an appropriate reject cause and SM BOT to the UE 1 for each APN, to which there is activated EPS bearer context in the serving node 3. In this way the serving node 3 suppresses the NAS (E)SM signalling from the UE 1 for all APNs (for the duration of the SM BOT time).

The NAS (E)SM message can be a solicited NAS (E)SM message, e.g. a NAS (E)SM Reject message if the UE 1 has sent (E)SM request, and additionally another unsolicited NAS (E)SM message(s) for the other APNs, to which an active EPS bearer context is available (e.g. Deactivate EPS Bearer Context Request(s)).

If Group-based NAS (E)SM CC applies and UE 1 sends NAS SM Request related to e.g. APN_A, MSC/MME/SGSN 3 sends NAS SM Reject message regarding APN_A and SM BOT. Additionally, the MSC/MME/SGSN 3 sends additional NAS (E)SM message (e.g. Deactivate EPS Bearer Context Request) including APN_B and SM BOT to indicate (E)SM CC to both APN_A and APN_B. (E)SM BOT for APN-A and SM BOT for APN-B may have the same values, so that UE 1 can be optimized by implementation to run only a single (E)SM BOT time(r) for all APNs or EPS bearer contexts.

The detailed procedure of the embodiment of FIG. 2 is as follows:

Step 0): The UE 1 attaches to the network and the MME 3 retrieves the UE's 1 subscription data from the HSS 4 (and/or, possibly, from the HLR, not shown in FIG. 2). The UE's 1 subscription data contains various subscription parameters and, additionally, a Group ID_X parameter, which indicates that the UE 1 is a member of Group X. Further, the UE 1 activates a separate EPS bearer to APN_A and to APN_B, respectively.

Step 1): Based on an increased NAS SM signalling, the MME 3 decides to activate the Group-based NAS level SM CC for Group X.

Step 2): At some point of time the UE 1 sends a NAS SM signalling message to the MME 3, which can be for ESM bearer establishment, modification or deactivation (e.g. BEARER RESOURCE ALLOCATION REQUEST, or PDN CONNECTIVITY REQUEST, or BEARER RESOURCE MODIFICATION REQUEST). The message may explicitly contain the related APN (e.g. APN_A), or the MME 3 may implicitly determine to which APN the message is related, e.g. in case that the PDN CONNECTIVITY REQUEST message is for the default bearer.

Step 3): The MME 3 detects that the UE 1 is member of a particular group (i.e. Group ID_X in the present scenario), to which the NAS SM Congestion Control is applied. The UE 1 belongs to a group, if the corresponding group identifier (e.g. Group ID_X) is stored in the UE's 1 subscription context received from the HSS 4 (i.e. it is not necessary that the UE 1 itself is aware of the group subscription). It is assumed that the (E)SM congestion control is applied for all APNs for the UE 1 belonging to said particular internal group, and not for a specific APN.

The MME 3 further determines that the UE 1 has active (E)PS bearer contexts to APN_A and APN_B (as established in the above Step 0)). Thus, the MME 3 decides to send in parallel separate NAS (E)SM messages to the UE 1 per APN, to which an (E)PS bearer context is activated. The MME 3 usually knows the APN of the UE's 1 NAS (E)SM request message based on the EPS bearer ID included in the message. If the (E)SM request message from the UE 1 does not contain an EPS bearer ID or APN information (e.g. because it is for default EPS bearer), then the MME 3 can decide to apply or not to apply the NAS level congestion control, including the (E)SM BOT.

It should be noted that a scenario, where the MME 3 decides to apply the NAS (E)SM CC although the APN or EPS bearer ID is not included in the UE's 1 (E)SM request message, is different from the state-of-the-art, where the MME 3 does not include an SM BOT if the UE's 1 (E)SM request message does not include EPS bearer ID or APN information.

Step 4.1): The MME 3 sends a reply to the UE's 1 (E)SM request message sent in step 2), which is a NAS (E)SM Reject message (e.g. BEARER RESOURCE ALLOCATION REJECT, or PDN CONNECTIVITY REJECT, or BEARER RESOURCE MODIFICATION REJECT) including an (E)SM BOT time to indicate the activation of the NAS SM CC for APN_A. The NAS (E)SM Reject message includes the EPS bearer ID or APN information as provided in the UE's 1 (E)SM request message.

Step 4.2): The MME 3 sends a NAS (E)SM message to the UE 1 indicating the suppressing of (E)SM signalling to further EPS bearer contexts including the (E)SM BOT time(r) to any of the activated EPS bearers to additional APNs, i.e. in the present case APN_B. For example, the NAS (E)SM message from the MME 3 to the UE 1 can be a DEACTIVATE EPS BEARER CONTEXT REQUEST message, or ESM STATUS message, or some other (E)SM message suitable for the transport of the (E)SM BOT to the UE 1. In this case The MME 3 deactivates the EPS bearer to APN_B by sending the NAS Deactivate EPS Bearer Context Request message to the UE 1 with a Session Management back-off timer. If the Session Management back-off timer is included in the NAS Deactivate EPS Bearer Context Request message then the cause “reactivation requested” should not be set.

Steps 4.1) and 4.2) are performed in parallel. The MME 3 sends a NAS (E)SM message to the UE 1 per APN, to which a EPS bearer context is active. The purpose of this step is to suppress the NAS SM signalling from the UE 1 for the SM BOT time for all APNs, to which the UE 1 has an active (E)PS bearer.

In FIG. 2, Steps 4.1) and 4.2) are depicted to show in brackets the parameters “APN_A” and “APN_B”. Usually, the NAS (E)SM message for activated EPS bearer context contains the EPS bearer ID, which can be linked in the UE 1 with the related APN. Thus, the parameters “APN_A” and “APN_B” should be understood to be placeholders for EPS bearer ID or other parameters identifying the APN affected by the NAS (E)SM signalling.

Step 5): After receiving the NAS (E)SM message from the serving node, the UE 1 starts the SM BOT timer (e.g. timer T3396 as described in 3GPP TS24.301) with the received value and the UE 1 does not send another PDN CONNECTIVITY REQUEST message for the same APN until the SM BOT (timer T3396) expires. A more detailed behaviour of the timer is explained in 3GPP TS24.301 section 6.4.4.3, which is incorporated herein by way of reference.

It should be noted that the MME 3 can use the same value of the (E)SM BOT in steps 4.1) and 4.2), as both messages are sent in parallel. The use of the same value for the (E)SM BOT can lead to the following implementation optimizations in both UE 1 and SGSN/MME 3: The UE 1 has to store only a single back-off timer for all APNs, instead of running a back-off timer per APN as in the state-of-the-art, and the serving network node (MSC/SGSN/MME 3) has to store only a single NAS SM back-off timer for all APNs instead of storing a back-off timer per UE 1 per APN as in the state-of-the-art.

With other words, if group specific NAS level congestion control for Session Management signalling is active for a particular group of UEs, the SGSN/MME's behaviour is similar to that in 3GPP TS23.401 section 4.3.7.4.2.2 (which is incorporated herein by way of reference), but with the following modifications:
For a UE that belongs to said particular group, (E)SM congestion control can be applied for all APNs and not for a specific APN of that UE.
The SGSN/MME rejects the (E)SM request from the UE belonging to said particular internal group (e.g. PDN Connectivity, Bearer Resource Allocation or Bearer Resource Modification Requests) with a Session Management back-off timer. If (E)PS bearer context(s), PDN connection(s) and/or PDP context(s) to additional APNs exist in the SGSN/MME, the SGSN/MME re-uses the established (E)SM signalling connection and sends NAS (E)SM message to the UE indicating the suppressing of (E)SM signalling (e.g. Deactivate EPS bearer context request message) including e.g. the same back-off timer to the other APNs.

When group specific NAS level congestion control for Mobility Management signalling is active for a particular internal group, the MME's behaviour is similar to that of the state-of-the-art in 3GPP TS23.401, but applied to UEs subscribed to said particular internal group rather than subscribed to a particular APN.

There are two main advantages of the embodiment from FIG. 2 compared to the possible solution from FIG. 1: (a) the existing NAS (E)SM signalling connection used for step 2) is re-used to signal the (E)SM signalling suppression for other APNs, for which MME 3 has activated EPS context; and (b) the same (E)SM BOT can be used in all (E)SM messages from MME 3 to UE 1 per APN.

Another embodiment achieves an improvement to the solution described above in connection with FIG. 2 in terms of avoiding the NAS SM signalling from the UE 1 also for APNs, to which the UE 1 has not activated EPS bearers yet, but can possibly send NAS (E)SM request message during the (E)SM BOT is running to other APNs. For this purpose, when the MME 3 (or SGSN/MSC) receives a NAS (E)SM signalling message for any APN, the MME 3 (or SGSN/MSC) checks the UE's 1 subscription context about all subscribed APNs. Then the MME 3 (or SGSN/MSC) sends a NAS (E)SM message to the UE 1 including SM BOT for each of the subscribed APNs, independent of whether an EPS bearer context is activated for this APN or not. In this way the UE 1 is prevented to send any NAS SM signalling to any of the subscribed APNs until the SM BOTs per APN expire.

The NAS (E)SM message sent from the MME 3 (or SGSN/MSC) to the UE 1 can be a modification of existing NAS ESM messages (as will be explained in detail below), e.g. ESM INFORMATION REQUEST, or ESM STATUS, Modify EPS bearer context request or some other message containing the SM BOT, however, as there is no EPS bearer established, the Informational Element “EPS Bearer Identity” within the NAS ESM message should indicate the specific APN, to which the SM BOT applies.

A benefit of the embodiment with no UE 1 impact as described above in connection with FIG. 2 is that no NAS protocol modifications are needed, and thus, no modification to the serving network node 3 and the UE 1. However, a disadvantage of this embodiment is that the MME 3 needs to send to the UE 1 a NAS (E)SM message per each APN. With other words multiple NAS (E)SM messages may be sent from the MME 3 to the UE 1 if the UE 1 has activated EPS bearer contexts to multiple APNs. The following embodiment avoids this problem and proposes a single NAS (E)SM message from MME 3 to UE 1 to prevent the UE's 1 NAS (E)SM signalling to all APNs.

An important aspect of this embodiment is that the NAS (E)SM message from MME 3 to UE 1 contains a specific indication that the included SM BOT is valid for all APNs (PDN connections) of the UE 1. It should be noted that currently the NAS (E)SM signalling is related to a particular EPS bearer or PDN connection (thus APN), but there is no general (E)SM signalling procedure which affects all NAS (E)SM connections. Therefore, the proposed embodiment introduces a new functionality in the NAS (E)SM protocol, i.e. the ability to exchange general (E)SM information affecting the UE 1 and not only the specific PDN connection or EPS bearer context.

The new (E)SM functionality for general (E)SM UE impact can be implemented in several ways. The following list describes four different embodiments:

Embodiment (1): A new (E)SM message(s) can be introduced, which is used for common/general (E)SM information exchange between the UE 1 and serving network node, e.g. MME 3. This new common/general (E)SM message can carry (E)SM parameters applicable for all (E)SM sessions between the UE 1 and the MME 3. The parameters carried within the common/general (E)SM message apply to all activated E(SM) connections or sessions. One of those common (E)SM parameters can be the (E)SM BOT. This new (E)SM message can be defined in the direction from UE 1 to network, but also in the direction from the network, i.e. from MSC/SGSN/MME 3, to the UE 1. To indicate that the NAS (E)SM message is a common/general (E)SM message, one possible implementation is to specify new type(s) of message(s) in the (E)SM protocol.

Embodiment (2): An existing (E)SM message can be used, but a new Information Element can be introduced which indicates to the receiving party (UE 1 or serving network node) that the other Information Elements within this message are related to all existing (E)SM contexts or to all possible (E)SM procedures or (E)SM signalling. For example, if this new “general” IE is included in the (E)SM message and also a SM BOT IE is included, then the SM BOT is valid for the (E)SM signalling from the UE 1 for all (subscribed) APNs.

Embodiment (3): An existing (E)SM message can be used, but a new type of (E)SM back-off timer is introduced, whose scope is for (a) all activated (E)PS bearer/DPD/PDN contexts and/or for (b) all (subscribed) APNs. In such a case the APNs or EPS bearer IDs do not need to be listed explicitly in the (E)SM message. For example, the new (E)SM BOT time(r) can be called “Group” (E)SM BOT. A new timer type value has to be assigned to this Group (E)SM timer. For example, the current (E)SM BOT has the value of T3396, whereas the new timer may have a value of T3399.

Embodiment (4): An existing (E)SM message can be used, the message includes a list of APNs or EPS bearer IDs, to which the other parameters within the message apply. For example, the (E)SM message can be sent as reply message to a particular NAS (E)SM Request (i.e. within a particular EPC bearer context), however, if the (E)SM reply message contains a list of additional EPS bearer IDs, or APNs, or other indicators or (E)PS bearer contexts, the receiver of the (E)SM reply message applies the parameters of the message to the indicated list of (E)PS bearer contexts or APNs.

If the UE 1 receives NAS SM Reject message according to one of the Embodiments (1) to (4) from above, the UE 1 is prohibited to send/receive NAS (E)SM signalling for (1) all activated EPS bearer contexts, or for (2) all subscribed APNs.

However, the UE 1 is still allowed to send NAS (E)MM signalling, and thus, to perform Service Request procedure and send/receive data, but UE 1 is not allowed to establish/modify/release any EPS bearers.

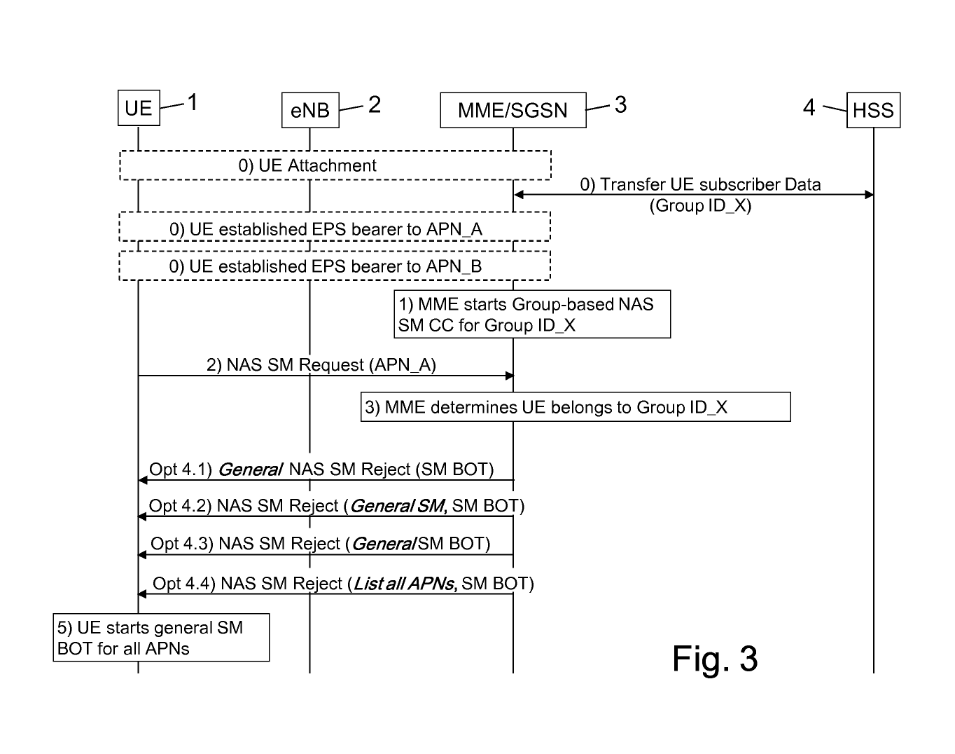

The detailed procedure of the embodiment of FIG. 3 is as follows:

Step 0): The UE 1 attaches to the network and the MME 3 retrieves the UE's 1 subscription data from the HSS 4 (possibly also HLR). The UE's 1 subscription data contains various subscription parameters and, additionally, the Group ID_X parameter, which indicates that the UE 1 is a member of Group X. Further, the UE 1 activates separate EPS bearers to APN_A and to APN_B, respectively.

Step 1): Based on an increased NAS SM signalling, the MME 3 decides to activate the Group-based NAS level SM CC for Group ID_X.

Step 2): At some point of time the UE 1 sends NAS SM Request message to MME 3. This message can be for ESM bearer establishment, modification or new PDN establishment to a new APN. The message may explicitly contain the related APN (e.g. APN_A). Alternatively, however, the MME 3 may implicitly determine to which APN the message is related.

Step 3): At the time of an incoming NAS SM request message from the UE 1, the MME 3 detects that the UE 1 is member of the Group ID_X, to which the NAS SM signalling is applied (i.e. which is subject to NAS level congestion control handling). The MME 3 further determines that the UE 1 has active EPS bearer contexts to APN_A and APN_B, but may have also other subscribed APNs, to which no EPS bearer context has been activated so far. Based on this signalling congestion situation and the detection that the UE 1 is member of the Group ID_X, the MME 3 decides to suppress the NAS (E)SM signalling from the UE 1 for all bearers. This step is similar to step 3) from the embodiment of FIG. 2.

Step 4.1): This option for suppressing the NAS (E)SM signalling from the UE 1 for all EPS bearers is based on Embodiment (1) from above. The MME 3 sends—in reply to the UE's 1 NAS SM Request message of step 2)—a new common/general NAS ESM Reject message. This message can be based on the existing NAS (E)SM messages e.g. BEARER RESOURCE ALLOCATION REJECT, or PDN CONNECTIVITY REJECT, or BEARER RESOURCE MODIFICATION REJECT, but a new message type is defined for the above messages. The message may include a SM BOT time to indicate the activation of the NAS SM CC for all APNs.

Step 4.2): This step shows the suppression of the NAS (E)SM signalling from the UE 1 for all EPS bearers is based on Embodiment (2) from above. The MME 3 sends a reject message in reply to the UE's 1 NAS SM Request message of step 2). This reject message is a NAS (E)SM Reject message including or not a particular reject cause (e.g. BEARER RESOURCE ALLOCATION REJECT, or PDN CONNECTIVITY REJECT, or BEARER RESOURCE MODIFICATION REJECT) including a new indication that the message is applicable to (a) all activated EPS bearer contexts and/or to (b) all subscribed APNs. For example, the new indication may be called “all APN congestion indication” or “any APN congestion indication” or “group congestion indication”. Additionally the NAS (E)SM Reject message may include a SM BOT time to indicate the activation of the NAS SM CC for all APNs. The format of the included SM BOT may be the format of an existing one, e.g. T3396 from 3GPP TS24.301 or a new specified NAS SM/MM BOT format.

Step 4.3): This step shows the suppressing the NAS (E)SM signalling from the UE 1 for all EPS bearers is based on Embodiment (3) from above. The MME 3 sends an existing (E)SM reject message, but a new type of (E)SM back-off timer is introduced, whose validity if for (a) all activated (E)PS bearer contexts or for (2) all (subscribed) APNs.

Step 4.4): This step shows the suppressing the NAS (E)SM signalling from the UE 1 for all EPS bearers is based on Embodiment (4) from above. The MME 3 sends an (E)SM message of existing type, but the message content includes a list of APNs or EPS bearer IDs, to which the other parameters within the message apply.

Step 5): After receiving the NAS (E)SM message from the serving network node in one of the steps 4.1), or step 4.2), or step 4.3), or step 4.4), the UE 1 does not send (E)SM signalling towards the network and starts (E)SM BOT timer (e.g. timer T3396 as described in 3GPP TS24.301 or TS24.008) with the received value. The UE 1 does not send another PDN CONNECTIVITY REQUEST message for any of the APNs until the SM BOT (e.g. timer T3396) expires. A more detailed behaviour is explained in 3GPP TS24.301 section 6.4.4.3.

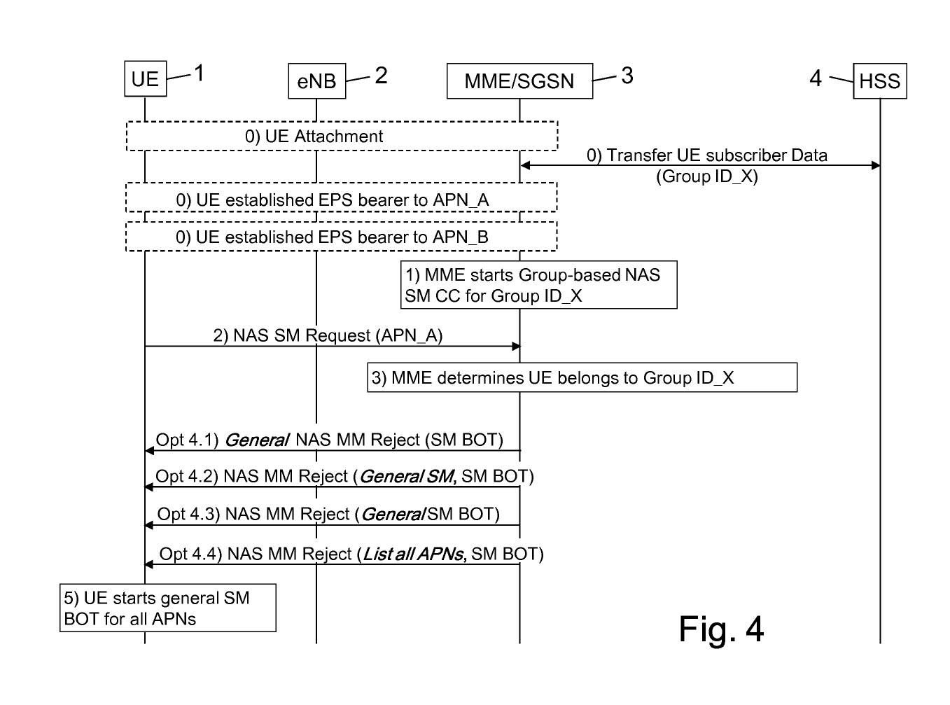

In yet another alternative for step 4) of FIG. 3, i.e. steps 4.1)-4.4), the MME 3 (or, as the case may be, the SGSN or MSC), instead of sending NAS (E)SM reject messages, may send NAS (E)MM messages, as illustrated in FIG. 4, that allow the UE 1 belonging to a particular group to be blocked in sending a NAS ESM requests for all APNs. With other words, to prevent unnecessary signalling from the UE 1 to existing or new EPS bearer context(s) to any APN(s), the MME 3 sends an NAS (E)MM message to force the UE 1 to stop sending a NAS (E)SM request message for any APNs for a period of time. The modifications of existing NAS (E)SM message described above in connection with steps 4.1)-4.4) of FIG. 3 apply likewise for the NAS (E)MM messages employed in connection with the embodiment of FIG. 4.

The NAS (E)MM message sent from the MME 3 (or SGSN/MSC) to the UE 1 contains an indication that all (E)SM siganalling from the UE 1 shall be suppressed for the time duration of the back-off timer (BOT). As known the NAS (E)MM message is used in the UE 1 for updating or reconfiguring the NAS Mobility Management sub-layer, but for the purposes of the present embodiment, the NAS (E)MM message conveys information related to the NAS Session Management sub-layer, and more specifically to block the NAS Session Management sub-layer signalling. In the future the NAS (E)MM message can be used for other NAS Session Management sub-layer controlling.

After receiving the NAS (E)MM message as per step 4) of FIG. 4, the UE 1 behaviour is modified to not initiate any Session Management procedures for any APNs while the timer for stop sending a NAS ESM request message is running, corresponding to the UE's 1 behavior in case of NAS (E)SM reject messages, as described in connection with FIG. 3.

The solution with UE 1 impact as described above in connection with FIGS. 3 and 4 has impact on the NAS (E)SM protocol. The essential change is that the (E)SM signalling exchange does not apply to a single (E)PS bearer context or PDP context or PDN connection, but the (E)SM signalling exchange applies to all session management connections, i.e. to all (E)PS bearer context or PDP context or PDN connection (said different to all APNs). This essential change of the semantic of the (E)SM signalling protocol implies also corresponding changes to the Serving network node (MSC, SGSN/MME) and its NAS (E)SM implementation, and to the UE 1 and its NAS (E)SM implementation.

The benefit of the solutions from FIGS. 3 and 4 compared to the possible solution from FIG. 1 and the solution from FIG. 2 is that only a single message is sent in step 4 from the MSC/SGSN/MME 3 to the UE 1 in order to suppress the (E)SM signalling for all APNs. On the other hand the disadvantage is that NAS (E)SM protocol changes are needed to all of the Embodiments (1) to (4), which would require modifications to the serving network node, e.g. MME 3, and to the UE 1.

To summarize, embodiments in connection with FIGS. 3 and 4 may implement the following aspects:

1) At the time of an incoming NAS (E)SM request message from a UE, a serving network node (MSC/SGSN/MME) detects that the UE is member of a group that is a subject to NAS level congestion control handling and the serving network node instructs the UE to suppress all NAS (E)SM signalling including the steps of:

a. In addition to sending NAS (E)SM reject message to the UE as reply to the NAS (E)SM request message, the serving network node sends also NAS (E)SM signalling message to the UE targeting activated or not activated EPS bearer context(s) even though the UE has not requested NAS (E)SM signalling procedure for this activated or not activated EPS bearer context(s).

b. The NAS (E)SM signalling from the serving network node to the UE for suppressing the UE's NAS (E)SM signalling for all activated or not activated EPS bearer context(s) is send in parallel for all activated or not activated EPS bearer context(s)

c. The NAS (E)SM signalling from the serving network node to the UE for suppressing the UE's NAS (E)SM signalling for all activated or not activated EPS bearer context(s) includes (E)SM back-off time(r) for which the UE is not allowed to send signalling to the network where the same value of the time(r) is used for the different activated or not activated EPS bearer context(s).

2) The serving network node suppresses the NAS (E)SM signalling of a UE for all APNs to which the UE has an active EPS bearer context or still not active EPS bearer context by one of the following steps:

a. the serving network node sends a new type of (E)SM signalling message to the UE, whereas the new message type has the scope of all UE's APNs, i.e. a general/common NAS (E)SM message targeting all activated and non-activated EPS bearer contexts, or

b. the serving network node sends NAS (E)SM reject message having a list of EPS bearer IDs or APNs to which the message applies, whereas the NAS (E)SM reject message may or may not include a back-off timer with value the time for suppressing the signalling.

The solutions described above in connection with FIGS. 2-4 do not consider the aspect of whether the UE indicates a low access priority in the NAS signalling message or not. In the state-of-the-art mechanism, the NAS (E)SM congestion control is applied to UEs indicating low access priority. However, the introduction of Group based NAS level congestion control may extend this concept and allow the serving network node (MSC/SGSN/MME) to apply the NAS level congestion control (both MM CC and SM CC) to UEs which are part of the Group causing the signalling congestion, independent whether the UEs indicate or does not indicate low access priority.

With other words, the solution is also applicable to normal priority UEs and not restricted to low priority UEs.

In a special case where some members of the Group use low access priority indicator and other members of the group do no use low access priority indicator, according to the 3GPP currently defined mechanism in TS23.401, the serving network node applies the NAS level CC only to the UEs using low access priority indicator. According to an embodiment of the present invention, the serving network node can decide to apply the Group based congestion control to all members of the group independent of whether the UE has indicated low access priority in the NAS signalling message or not. According to another embodiment of the invention, the serving network node can decide to apply the Group based congestion control only to those members of the group, which have indicated low access priority in the NAS signalling message.

In case that the (E)SM BOT is already activated in the UE, 3GPP TS23.401 specifies the following condition: “If the UE is configured with a permission for overriding low access priority and the Session Management back-off timer is running due to a reject message received in response to a request with low access priority, the upper layers in the UE may request the initiation of Session Management procedures without low access priority.”

This condition needs to be changed if the Group based congestion control applies to all members of the group independent whether the UE has indicated or not low access priority. In case that the UE has not indicated a low access priority and the NAS (E)SM request has been rejected with (E)SM BOT, the UE keeps the timer running until upper layers in the UE request initiation of Session Management procedures with a high priority access or emergency services.

Many modifications and other embodiments of the invention set forth herein will come to mind the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for signalling congestion avoidance based on Non-Access Stratum (NAS) level congestion control in a mobile network, the method comprising:
activating or starting a group specific NAS level congestion control mechanism that applies to a group of terminals,
receiving at a serving node of a terminal of the group of terminals an NAS Session Management (SM) request message from the terminal related to a particular access point name (APN), and
transmitting from the serving node of the terminal to the terminal one or more NAS reject messages that indicate suppression or prevention of NAS SM signalling of the terminal that is related either to all APNs to which the terminal has established or activated IP bearers or to all APNs to which the terminal has a subscription.

2. The method according to claim 1, wherein the serving node of the terminal, upon receiving from the terminal an NAS SM request message related to a particular APN, transmits to the terminal a general NAS SM reject message related to all APNs to which the terminal has a subscription or a general NAS Mobility Management (MM) reject message related to all APNs to which the terminal has a subscription.

3. The method according to claim 1, wherein the serving node of the terminal, upon receiving from the terminal an NAS SM request message related to a particular APN, transmits to the terminal an NAS SM reject message or an NAS MM reject message that is adapted to contain an information element that indicates to the terminal that the NAS SM reject message or the NAS MM reject message relates to all APNs to which the terminal has a subscription.

4. The method according to claim 1, wherein the terminal's serving node, upon receiving from the terminal an NAS SM request message related to a particular APN, transmits to the terminal an NAS SM reject message or an NAS MM reject message that is adapted to contain a back-off timer for the terminal's NAS SM signalling suppression or prevention configured to apply to all APNs to which the terminal has a subscription.

5. The method according to claim 1, wherein the serving node of the terminal, upon receiving from the terminal an NAS SM request message related to a particular APN, transmits to the terminal an NAS SM reject message or an NAS MM reject message that is adapted to contain a list of APNs that indicates those APNs to which the NAS SM reject message or the NAS MM reject message applies.

6. The method according to claim 1, wherein the serving node of the terminal, upon receiving from the terminal an NAS SM request message related to a particular APN, transmits to the terminal individual NAS SM reject messages per each APN to which the terminal has established or activated IP bearers.

7. The method according to claim 6, wherein the individual NAS SM reject messages are transmitted in parallel.

8. The method according to claim 6, wherein a value of a back-off timer for NAS SM signalling suppression or prevention of the terminal that is contained in the individual NAS SM reject messages is the same for all of -the individual NAS SM reject messages.

9. A terminal device for use in a mobile network, the terminal device comprising:
a communications unit for communication with a serving node within the mobile network, and
a control unit for controlling operation of the communications unit,
wherein the control unit is configured to instruct the communications unit, upon receiving from the serving node one or more NAS reject messages that indicate suppression or prevention of the NAS SM signalling of the terminal that is related either to all APNs to which the terminal has established or activated IP bearers or to all APNs to which the terminal has a subscription, to not initiate any NAS SM signalling related to the respective APNs.

10. The terminal device according to claim 9, wherein the control unit is configured, upon receiving at the communications unit an NAS SM reject message or NAS MM reject message containing an information element that indicates that the NAS SM reject message or NAS MM reject message relates to all APNs to which the terminal has a subscription, to instruct the communications unit to not initiate any NAS SM signalling related to the respective APNs.

11. The terminal device according to claim 9, wherein the control unit is configured, upon receiving at the communications unit a an NAS SM reject message or an NAS MM reject message containing a back-off timer for the NAS SM signalling suppression or prevention of the terminal that is configured to apply to all APNs to which the terminal has a subscription, to instruct said the communications unit to not initiate any NAS SM signalling related to the respective APNs while the back-off timer is running.

12. The terminal device according to claim 9, wherein the control unit is configured, upon receiving at the communications unit an NAS SM reject message or NAS MM reject message containing a list of APNs that indicates those APNs to which the NAS SM reject message or the NAS MM reject message applies, to instruct the communications unit to not initiate any NAS SM signalling related to those APNs indicated in the list.

13. A serving node for use in a mobile network, the serving node comprising:
a communications unit for transmitting and receiving messages, and
a control unit for controlling operation of the communications unit,
wherein the control unit is configured to detect when a group specific NAS level congestion control mechanism that applies to a group of terminals is activated within the mobile network, and
wherein the control unit is further configured to instruct the communications unit, upon receiving from a terminal of the group an NAS SM request message related to a particular APN, to transmit to the terminal one or more NAS reject messages that indicate suppression or prevention of NAS SM signalling of the terminal that is related either to all APNs to which the terminal has established or activated IP bearers or to all APNs to which the terminal has a subscription.

14. The serving node according to claim 13, wherein said-the control unit is configured, upon receiving at the communications unit an NAS SM request message from a terminal, to determine whether the terminal belongs to a group for which an activated group specific NAS level congestion control mechanism applies.

15. The serving node according to claim 13, wherein the mobile network is a 3G UMTS network or a 4G LTE network and the serving node is an SGSN or an MME.
